(19) United States
(12) Patent Application Publication
(10) Pub. No.: US 2007/0124458 A1
(43) Pub. Date: May 31, 2007

(54) Method and system for event notification on network nodes

(75) Inventor: Shashi Kumar, San Jose, CA (US)

Correspondence Address: Trellis Intellectual Property Law Group, PC, 1900 EMBARCADERO ROAD, SUITE 109, PALO ALTO, CA, 94303, US

(73) Assignee: Cisco Technology, Inc., San Jose, CA (US)

(21) Appl. No.: 11/291,297

(22) Filed: Nov. 30, 2005

(51) Int. Cl. G06F 15/173

(52) U.S. Cl. 709/224

(57) ABSTRACT

A method and a system for notifying a user regarding events occurring on nodes in a network are provided. Information related to the events occurring on the nodes is received at a network device. The received information is converted into a syndicated format. A part or whole of the converted information is transmitted to notify the user about the events occurring on the nodes in the network, when the user queries for the converted information. The user can be notified without browsing a homepage of the network device.

### BACKGROUND OF THE INVENTION

1. Field of Invention

Embodiments of the invention relate to network devices in general. More specifically, embodiments of the invention relate to methods and systems for automatic notification of events on network devices in a network.

2. Description of the Background Art

A typical network includes a number of network-attached devices coupled to network nodes, a wired or wireless medium for connecting the nodes, and network infrastructure devices, such as hubs switches or routers. The network infrastructure devices inter-connect network nodes to each other and enable nodes in the network to exchange information. Unless otherwise indicated, the phrase “network devices” includes both network attached devices and network infrastructure devices.

The network-attached and infrastructure devices are typically monitored for any conditions that may warrant administrative attention. Thus, when an anomaly is detected, a network administrator can review an event record that describes any network problem that disrupts or threatens to disrupt the exchange of information.

Conventionally, each network device logs events to a system log. Further, the network device typically exports the system log to a Syslog receiver or sends it as a trap to Simple Network Management Protocol (SNMP) management stations, which are monitored by the network administrator.

SNMP is an application layer protocol that facilitates exchange of management information between network devices and is commonly deployed on a network. SNMP helps an administrator to manage the network and its nodes because logged events are stored and can be referred to when required. However, in small networks, which lack dedicated administrator, the network is often managed by using an embedded web-based device manager that requires the administrator to periodically access the device manager to review the event log.

Conventionally, the administrator refers to a network device's homepage for obtaining information regarding logged events. While the details regarding events are stored as logs, there is no provision for an asynchronous notification of the events unless the administrator is monitoring the network at the monitoring station. Rather, the administrator has to browse the homepage of each network device to obtain information regarding the logged events. Therefore, the adminstrator may not be able to monitor multiple nodes and the network simultaneously especially if they are away from the monitoring station. Further, there may be no way for the administrator to know that events have occurred if they are not browsing the switch homepages. Therefore, it may be difficult for the administrator to keep a track of all the events at all nodes. What is needed is a method and a system for improved notification of events happening on a network device.

### BRIEF DESCRIPTION OF THE DRAWINGS

FIG. 1 illustrates an environment wherein various embodiments of the invention can be practiced.

FIG. 2 illustrates a system for notifying a user regarding an event, in accordance with various embodiments of the invention.

FIG. 3 is a flowchart illustrating a method for notifying an administrator regarding an event, in accordance with various embodiments of the invention.

FIG. 4 is a flowchart illustrating a method for notifying an administrator regarding an event, in accordance with an embodiment of the invention.

FIG. 5 is a schematic diagram illustrating a homepage of a network device, in accordance with an embodiment of the invention.

FIG. 6 is a schematic diagram illustrating a Really Simple Syndication (RSS) Feed, in accordance with various embodiments of the invention.

### DETAILED DESCRIPTION OF EMBODIMENTS OF THE INVENTION

Various embodiments of the invention provide methods, systems, and computer-readable media for notifying a user regarding an event on a node in a network. In the description herein for embodiments of the present invention, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention

Embodiments of the invention provide methods and systems for notifying a user regarding an event occurring at a node in a network. The network includes nodes connected to each other through a network infrastructure device. The network infrastructure device facilitates communication between various nodes of the network. The network infrastructure device can further facilitate communication with other networks. A user, such as an administrator, may be present to administer the functioning of the nodes and infrastructure devices in the network and, accordingly, manage the network. Information regarding various events occurring on the nodes is sent to the connected network infrastructure device. The administrator may refer to a homepage of the network infrastructure device to obtain the information regarding the various events occurring on the nodes and network infrastructure devices. This information may help the administrator in managing the network. However, it would be desirable for the administrator to be made aware of the various events, without having to access the homepage of the network infrastructure device.

The administrator is made aware of the events through common RSS feed aggregation capable applications. The application, referred to herein as the reader application, may be invoked by a web browser, email reader or by other programming techniques that supports RSS feed aggregation. In a preferred embodiment, the administrator, if authorized, is provided with a user name and password as is common practice in the art. With the user name and password, the administrator may subscribe to the RSS feed from each network infrastructure device.

According to various embodiments of the invention, the information regarding various events is converted into a syndicate format and stored in the network infrastructure device. The reader application queries the network infrastructure device for the converted information in the background. The network infrastructure device initially determines if the administrator is authorized to receive the converted information. Thereafter, if authorized, the converted information is sent to the administrator in the form of a Really Simple Syndication (RSS) feed. In accordance with various embodiments of the invention, the RSS feed provides a brief description of an event. The administrator may be notified about the events in the network without browsing the homepage of the network infrastructure device. The RSS feed may further include a link to the converted information. The administrator can browse the homepages for the detailed information regarding the event by following the link.

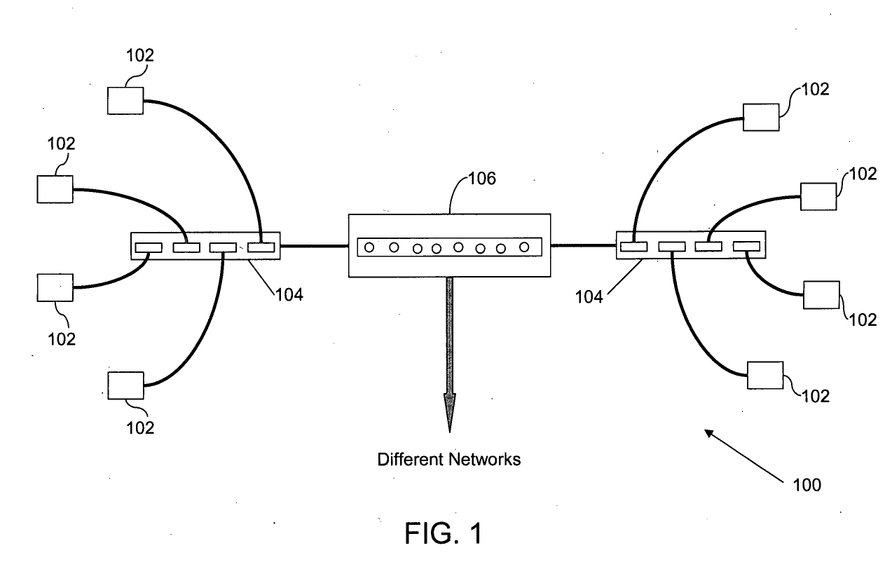

FIG. 1 illustrates an environment wherein various embodiments of the invention can be practiced. Environment 100 includes a network with nodes 102 connected to each other through a network infrastructure device 104. Further, a network infrastructure device 106 may be present, which connects nodes 102 to nodes in the other networks. Network infrastructure device 104 may be, for example, a hub or a switch. Network infrastructure device 104 connects nodes 102 with each other and allows them to communicate and exchange data. Further, the networks may be connected to other networks through another network infrastructure device 106. Network infrastructure device 106 may be, for example, a router. Network infrastructure device 106 connects the various networks. Therefore, network infrastructure device 106 allows nodes 102 of one network to communicate and exchange data with nodes across networks. Network infrastructure device 106 allows data transmission only if the data has a specific address of another device.

In accordance with various embodiments of the invention, network infrastructure device 104 can be, for example, a hub that connects nodes 102 and allows the network to maintain a half-duplex Ethernet. Nodes 102, which are connected by network infrastructure device 104, share a bandwidth. For example, if the network has the bandwidth of 10 Mbps, then each node 102, connected through network infrastructure device 104, gets only a portion of the 10 Mbps, if the other nodes 102 are communicating at the same time.

In accordance with various embodiments of the invention, network infrastructure device 104, for example, may be a switch that facilitates nodes 102 to communicate with each other and facilitate the network to maintain full-duplex Ethernet. Full duplex means that all the devices on the network can transmit data or information simultaneously. Nodes 102 communicate with the switch and may never communicate with each other directly. Nodes 102 can communicate on full 10 Mbps bandwidth without sharing the bandwidth with other nodes. This allows nodes 102 to transmit information to the switch, which further transmits the information to the other nodes at the same time. The environment is a collision-free environment.

In the network, a number of events occur at nodes 102, network infrastructure device 104, and network infrastructure device 106. For example, login, logout, accessing a file, saving the file, deleting the file, etc. Nodes 102 may communicate information regarding these events to network infrastructure device 104 in the network. In addition, nodes 102 may communicate information regarding the events to network infrastructure device 106. In an embodiment of the invention, network infrastructure device 104, and network infrastructure device 106 logs events based on activities that are noticed as information is exchanged through network infrastructure device 104 and network infrastructure device 106. In addition, network infrastructure device 104 and network infrastructure device 106 logs information pertaining to the internal operations. Further, logs are maintained in a Syslog receiver to store the information regarding the events. The logs describe the logged events. For example, a log may include details related to the node at which the event took place and the processing performed by the node. In addition, the log may include details regarding the time of the logged event or the log. This is useful in checking the real time of occurrence of the events. With the information contained in the logs, the administrator can monitor operation and troubleshoot network problems without having to individually access the home page for each network infrastructure device in the network.

The logs are preferably grouped according to the type of event. For example, one group of logs can be termed security logs that can include logs related to security operations, another group of logs can be termed desktop logs that can include logs related to desktop events, etc. For administering the network, an administrator may refer to the logged events at any time. The administrator may access the detailed description of the events by referring to the homepages of the network device at which the events are logged. This detailed description facilitates the administrator management of the network and correction of any disorder or problems in the network. In accordance with various embodiments of the invention, the administrator is notified regarding the events being logged on the network device without the administrator having to refer to the homepage of one or multiple network infrastructure devices such as network infrastructure device 104 or network infrastructure device 106. Advantageously, the administrator can easily track important events by receiving the notifications.

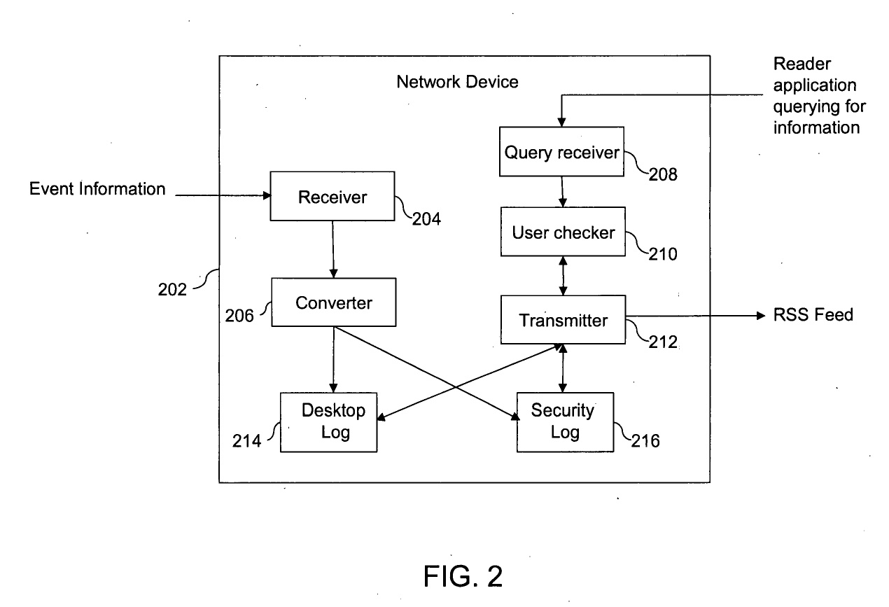

FIG. 2 illustrates a system for notifying an administrator regarding an event in the network, for example at node 102 or network infrastructure device 104 or network infrastructure device 106, in accordance with various embodiments of the invention. The system for notifying the administrator is included in a network device 202, which is typically network infrastructure device, such as network infrastructure device 104 or network infrastructure device 106. Network device 202 includes a receiver 204, a converter 206, a query receiver 208, a user checker 210, a transmitter 212, a desktop log 214, and a security log 216. Receiver 204 receives the information about the events occurring at nodes 102 or network infrastructure device 104 or network infrastructure device 106. The received information is a detailed description of the event. It includes details, such as information regarding the node at which the event took place, details related to the processing of the event at the node, and outcome of the event. Converter 206 converts the received information into a syndicated format and categorizes the information into separate files of various log categories, such as the desktop log 214 or the security log 216. The converted information is made available at designated locations, such as network device 202. Although only two such categories are illustrated in FIG. 2, one skilled in the art will appreciate that various categories may be defined based on the unique engineering considerations applicable to a given network. Accordingly, it will be appreciated that a network administrator may define various separate log categories in addition to the categories illustrated in FIG. 2.

One or more options for subscribing for the feeds are provided on the homepage of network device 202. The user subscribes from the homepage of network device 202 for a category of the feeds, which is of interest to the user. Query receiver 208 receives a query from a reader application regarding the converted information. Examples of the reader application include browser, email, newsreader or other applications programmed to perform such tasks. Through the reader application, the subscribed user queries the location of the converted information to see if there is any new information. User checker 210 checks if the subscribed user is authorized to receive the converted information that is queried for. Thereafter, transmitter 212 transmits the converted information in the form of a syndicated feed to notify the subscribed user about the logged event. The subscribed user can be an administrator.

The syndicated feed format can be, for example, XML (Extended Markup Language) based and can include structured representations of content, such as log entries and other related information.

Extended Markup Language or XML is a text format derived from Standard Generalized Markup Language (SGML). XML is a meta-language, which is a language used for describing other languages. A meta-language facilitates designing a proprietary markup language for a large number of different types of documents.

Syndicated formats, such as XML, provide syndicated information, for example, logs in a structured format, such as, a list of items. Syndicated formats may be used for aggregating information. Further, syndicated format can be used for providing a list of discrete items. For example, a title and a link can be included in the list for each logged event. A brief description of the information about the logged event can also be included. Examples of syndicated format include, but are not limited to, Really Simple Syndication (RSS) and Atom.

RSS is an XML format, designed for sharing titles and other contents. RSS syndicates information such as log events of activities on the network, events noticed by node 102 or information of internal operations of network infrastructure devices that are useful for operating and troubleshooting network problems or other information that can be broken down into discrete items and syndicated via RSS. Once information about each item is in RSS format, the reader application or an RSS-aware program checks the feed for changes and react to the changes in an appropriate way.

The RSS technology enables a user to subscribe for the latest information regarding logged events. The RSS technology additionally provides the link to the homepage containing the detailed description of the logged event. This information is made available at a designated location (within the network device 202) and an RSS/ATOM reader periodically queries these locations in the background to retrieve this information for subscribed users.

In accordance with an embodiment, this information is delivered as an XML file and may be called an RSS feed, stream or channel. According to various embodiments of the invention, after converter 206 converts the received information into the syndicated format, the availability of the converted information is indicated on the homepage of network device 202.

The option to subscribe for receiving the RSS feeds is provided on the homepage of network device 202. The subscription option is available even if there are no feeds available at that time. Once the administrator has entered in an authorized user name and password, they can select to receive the converted information by subscribing to the category of the feed. The authorized administrator, after subscribing, is thereafter notified about the converted information through the RSS feed whenever an event occurs.

Further, even when no users have subscribed to the category, the feeds related to the category are converted and stored. In addition, the availability of the feed for subscription is indicated on the homepage.

In an embodiment of the invention, network device 202 detects occurrence of events that need to be brought to the attention of the administrator. The detection could be based on hardware events, or messages from connected stations or internal processing of data.

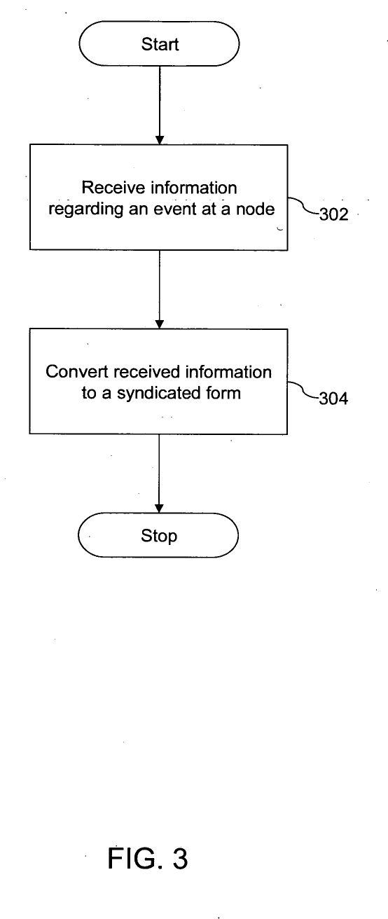

FIG. 3 is a flowchart illustrating a method for notifying an administrator regarding an event at node 102 or network infrastructure device 104 or network infrastructure device 106, in accordance with various embodiments of the invention. At step 302, receiver 204 receives information about the events occurring on nodes 102 or on network infrastructure device 104 or network infrastructure device 106. Nodes 102 or network infrastructure device 104 or network infrastructure device 106 send the detailed event information to network device 202. At step 304, converter 206 converts the received information into a syndicated format. In accordance with an embodiment of the invention, the received information is logged in an XML format defined by the RSS standard. The logged information is categorized according to the type of log as desktop log or security log. The user subscribes for the converted and categorized information through the homepage of network device 202. Availability of the converted information about the event is indicated on the homepages of network device 202. Therefore, the administrator is aware of the availability of the converted information on the homepage of network device 202.

The reader application queries the location in the background to see if any of the information is new. If there is new information, then the reader application indicates the availability of the new information. The user can then select the title of the new information and gather details of the events. The process of subscribing to the feed is independent and happens when the user visits the home page of the device (or during the setup of the switch). At that time, the user can show interest in getting notified about the events. Thus, in accordance with an embodiment of the invention, the homepage of network device 202 includes the option for subscription. One of more subscriptions may be available for the user to subscribe. The user subscribes to the homepage of network device 202 for receiving the converted information in the syndicated format. However, all users may not be able to access all the feeds. The administrator can configure restrictions on servicing of the feeds based on user id, source IP address or other such parameters that can be specified through an access control list. In an embodiment of the invention, the access control list may be maintained by user checker 210 to check if the subscribed user is authorized to receive the requested RSS feed. If user checker 210 identifies the subscribed user as authorized, then user checker 210 allows the subscribed user to receive the RSS feeds. Thereafter, a part of the syndicated information is sent in the form of the RSS feed to notify the subscribed user regarding the events occurring on node 102 or network infrastructure device 104 or network infrastructure device 106.

The RSS feed may be made available on the ‘reader application’. The reader application may include a web browser, e-mail supporting capabilities, etc. so notices can transmit at least part of the converted information via e-mail to the user or direct the user to a corresponding website. However, before notifying the administrator about the converted information, the reader application may query the availability of the converted information and check if the information is new. If the reader application identifies the converted information as new information, then the administrator is notified about the converted information in the form of the RSS feed.

The reader application may query the URL associated with the feed periodically. Network device 202 responds to the query with the data from the buffer associated with the feed. Network device 202 also checks against the configured access control lists to check if the requester is to be allowed access to the feed. If permitted, then network device 202 responds with the feed data. By referring to the RSS feed, the subscriber will be informed by the reader application about the events that have occurred in the network without browsing the homepages of the network device 202.

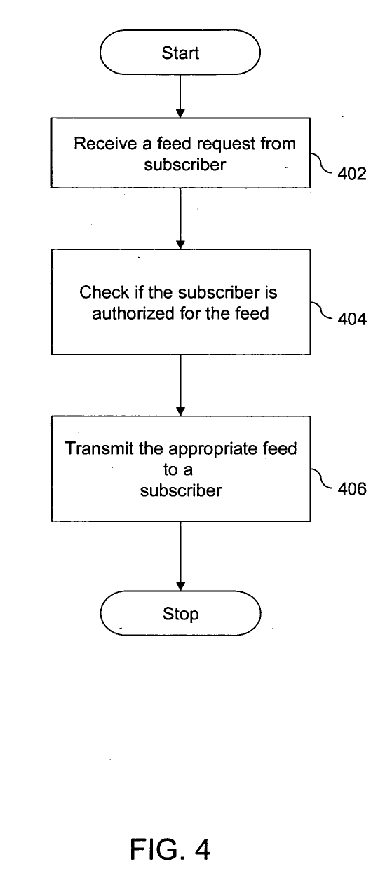

FIG. 4 is a flowchart illustrating a method for notifying an administrator regarding an event, in accordance with an embodiment of the invention. At step 402, query receiver 208 receives a request from the subscriber for receiving the converted information or the feeds. At step 404, user checker 210 checks if the subscribed user is authorized to receive the notification regarding the information, for which the request has been placed. At step 406, if user checker 210 identifies the subscribed user as authorized for receiving the converted information, transmitter 212 transmits the appropriate feed to the subscribed user.

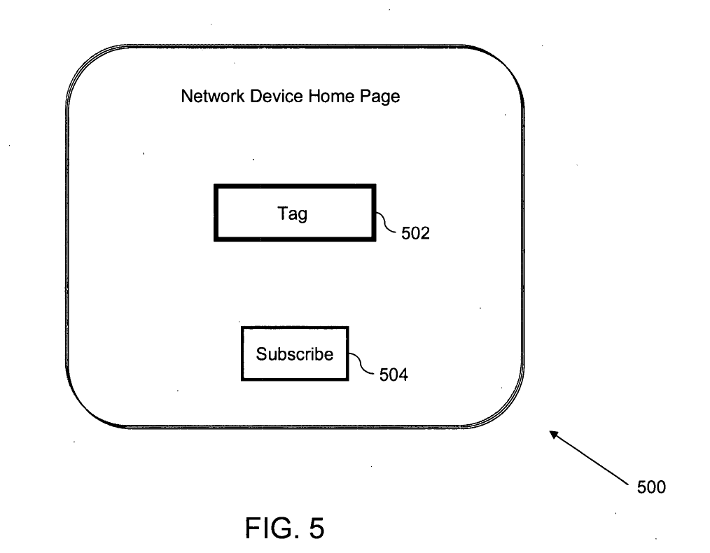

FIG. 5 is a schematic diagram illustrating a homepage 500 of a network device 202, in accordance with an embodiment of the invention. On homepage 500 of network device 202, a tag 502 is provided for indicating the availability of the converted information in the syndicated format. Tag 502 may be an embedded HTML tag. Tag 502 indicates to the reader application that converted information is available. The reader application may indicate this capability through a visual icon. Alternatively, homepage 500 explicitly states the availability of the RSS feed and provide the information that may be input into the reader application. Further, the reader application may detect tag 502 and check the availability of the RSS feed. Further, a subscribe option 504 is provided for subscription to the converted information. The converted information regarding the events is made available on homepage 500 of network device 202. Subscribe option 504 is available on homepage 500 for the administrator to subscribe to the required information. For example, subscribe option 504 may be, a button that enables the administrator to access the converted information in the syndicated format. Thereafter, the administrator may receive notifications about the events occurring on nodes 102, network infrastructure device 104, and network infrastructure device 106.

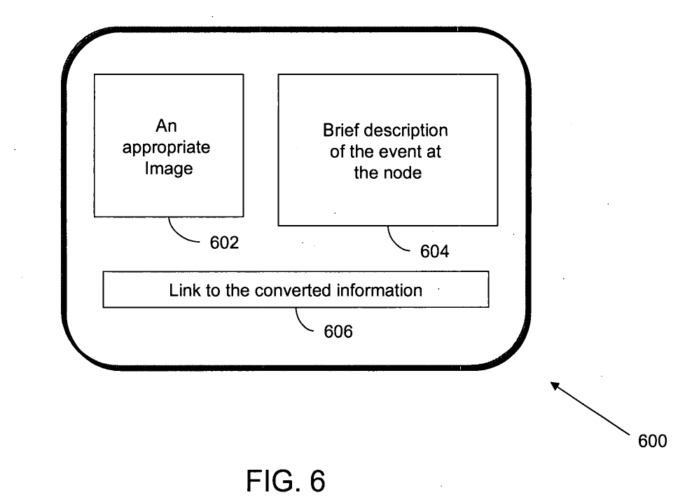

FIG. 6 is a schematic diagram illustrating an RSS feed 600, in accordance with various embodiments of the invention. RSS feed 600 may include an appropriate image 602, a brief description 604 of the event at node 102 and a link 606 to the converted information. Appropriate image 602 related to the converted information may be included in RSS feed 600. Appropriate image 602 may depict the theme of the event and may be used to communicate the state/type of the network device (possibly coded with overall status) in a visual manner. Brief description 604 of the event may include an overview of the event at node 102, network infrastructure device 104, or network infrastructure device 106. Link 606 provides the received and detailed information, which may be provided in RSS feed 600. Link 606 can provide various kinds of information, such as details of a problem that occurred, solution of the problem and the contact information required for solving the problem. The administrator may use link 606 to access and browse homepage 500 including the information about the event.

According to various embodiments of the invention, a method for notifying a user regarding an event occurring at a node in a network is provided. The method comprises receiving information related to the event at a network device; converting the received information into a syndicated format, the syndicated format being a structured representation of the received information; and transmitting at least a part of the converted information to notify the user, when a first condition is satisfied.

In an embodiment of the invention, a method for notifying a user regarding an event occurring at a node in a network is provided. The method comprises receiving information related to the event, the information being received at a network device; converting the received information into a syndicated format, the syndicated format being a structured representation of the received information; indicating the availability of the converted information on a homepage of the network device; receiving a query from a reader application of the subscribed user regarding the converted information; checking if the subscribing user is authorized for receiving the converted information; and providing at least a part of the converted information to notify the subscribed user if the subscribing user is authorized for receiving the converted information.

Embodiments of the invention provide an apparatus for notifying a user regarding an event occurring at a node in a network. The apparatus comprises a receiver receiving information at a network device, related to the event at a network device; a converter converting the received information into a syndicated format, the syndicated format being a structured representation of the received information; and a transmitter transmitting at least a part of the converted information to notify the user, when a first condition is satisfied. Satisfying the first condition simply means that the user must subscribe to receive the notification of the event before the RSS feed is sent to a browser, or other display platform. The RSS feed thereafter indicates new events as they are logged on a network infrastructure device. When the user selects to read the RSS feed, the browser displays the appropriate page on the switch. In this manner, the user is notified of network events without first having to access the switch. It is preferred that an email application that supports RSS feeds deliver this notice via email to the authorized user.

Embodiments of the invention provide a system for notifying a system administrator or other subscribed user regarding an event occurring or that has incurred at a node in a network. The system comprises means for receiving information related to the event, the information being received at a network device; another means for converting the received information into a syndicated format, the syndicated format being a structured representation of the received information; and still another means for transmitting at least a part of the converted information to notify the user, when a first condition is satisfied.

Embodiments of the invention provide a machine-readable medium including instructions executable by the processor. The machine readable medium comprises one or more instructions for receiving information related to the event, the information being received at a network device; another one or more instructions for converting the received information into a syndicated format, the syndicated format being a structured representation of the received information; and still another one or more instructions for transmitting at least a part of the converted information to notify the user, when a first condition is satisfied.

Embodiments of the invention provide an apparatus for notifying a network administrator or other subscribed user regarding an event occurring at a node in a network. The apparatus comprises a processor for executing instructions; and a machine-readable medium including instructions executable by the processor. The machine readable medium comprises one or more instructions for receiving information related to the event, the information being received at a network device; another one or more instructions for converting the received information into a syndicated format, the syndicated format being a structured representation of the received information; and still another one or more instructions for transmitting at least a part of the converted information to notify the user, when a first condition is satisfied.

Embodiments of the invention provide a method and a system to notify a user, such as an administrator who has subscribed to receive notification of events occurring on nodes 102 or network infrastructure device 104 or network infrastructure device 106 in a network. Nodes 102 or network infrastructure device 104 or network infrastructure device 106 send a detailed description of the events to network device 202 to facilitate the administrator to refer to the information. The subscribed administrator may be notified about the information in the form of RSS feed 600. The subscribed user queries network device 202 for the RSS feeds. Only the subscribed and authorized administrator is allowed to receive the RSS feeds. Therefore, the authorized and subscribed administrator may receive notifications as and when an event is logged and queried for. Accordingly, the administrator may remain informed about the events while browsing homepages other than those of network device 202, network devices 102, 104 and/or 106. Various embodiments of the invention facilitate the administrator to keep a track of all the important events taking place on nodes 102 in the network.

Further, there are different kinds of events and information where this notification has unique value. The most common situations are where the events are detected locally, and then the link provides more detailed information about the event. The administrator can then figure out what needs to be done. There could be other situations where a problem has proactively been detected on nodes 102 or network infrastructure device 104 or network infrastructure device 106. Accordingly, the description includes the details of the problem, and link 606, which may be used to initiate corrective action, are provided. For example, an Ethernet switch detects that duplex configuration on the port is full duplex, however, the end node is half-duplex, and so the switch can provide the link to the configuration of the port duplex with the correct value to use.

In another case, network device 202 can proactively detect problems in the network, not necessarily on nodes 102 or network infrastructure device 104 or network infrastructure device 106. In such cases, network device 202 can report the problem, and provide an URL to the root-cause of the problem. The root-cause of the problem is typically at a device in the network, where the problem can be resolved or corrected. Therefore, with the present invention, the administrator is directly led to the root-cause device or, more specifically, the device where the real problem has occurred. For example, a router with advanced capability detects that a node is transmitting harmful traffic into the network. In such a case, the router can report this information to the administrator, and provide the administrator link 606 to a home page of the device where node 102 is connected. To illustrate further, a network infrastructure device 106 may see a problem, report the problem, however, the pointer for corrective action may be on network infrastructure device 104 to which the offending node 102 is connected.

Although the invention has been discussed with respect to specific embodiments thereof, these embodiments are merely illustrative, and not restrictive, of the invention. For example, a ‘method and system for event notification on network nodes’ can include any type of analysis, manual or automatic, to anticipate the needs of communicating data.

Although specific protocols have been used to describe embodiments, other embodiments can use other transmission protocols or standards. Use of the terms ‘peer’, ‘client’, and ‘server’ can include any type of device, operation, or other process. The present invention can operate between any two processes or entities including users, devices, functional systems, or combinations of hardware and software. Peer-to-peer networks and any other networks or systems where the roles of client and server are switched, change dynamically, or are not even present, are within the scope of the invention.

Any suitable programming language can be used to implement the routines of the present invention including C, C++, Java, assembly language, etc. Different programming techniques such as procedural or object oriented can be employed. The routines can execute on a single processing device or multiple processors. Although the steps, operations, or computations may be presented in a specific order, this order may be changed in different embodiments. In some embodiments, multiple steps shown sequentially in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein for embodiments of the present invention, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Also in the description herein for embodiments of the present invention, a portion of the disclosure recited in the specification contains material, which is subject to copyright protection. Computer program source code, object code, instructions, text or other functional information that is executable by a machine may be included in an appendix, tables, figures or in other forms. The copyright owner has no objection to the facsimile reproduction of the specification as filed in the Patent and Trademark Office. Otherwise all copyright rights are reserved.

A ‘computer’ for purposes of embodiments of the present invention may include any processor-containing device, such as a mainframe computer, personal computer, laptop, notebook, microcomputer, server, personal data manager or ‘PIM’ (also referred to as a personal information manager), smart cellular or other phone, so-called smart card, set-top box, or any of the like. A ‘computer program’ may include any suitable locally or remotely executable program or sequence of coded instructions, which are to be inserted into a computer, well known to those skilled in the art. Stated more specifically, a computer program includes an organized list of instructions that, when executed, causes the computer to behave in a predetermined manner. A computer program contains a list of ingredients (called variables) and a list of directions (called statements) that tell the computer what to do with the variables. The variables may represent numeric data, text, audio or graphical images. If a computer is employed for presenting media via a suitable directly or indirectly coupled input/output (I/O) device, the computer would have suitable instructions for allowing a user to input or output (e.g., present) program code and/or data information respectively in accordance with the embodiments of the present invention.

A ‘computer readable medium’ for purposes of embodiments of the present invention may be any medium that can contain, store, communicate, propagate, or transport the computer program for use by or in connection with the instruction execution system apparatus, system or device. The computer readable medium can be, by way of example only but not by limitation, an electronic, magnetic, optical, electromagnetic, infrared, or semiconductor system, apparatus, system, device, propagation medium, or computer memory.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Further, at least some of the components of an embodiment of the invention may be implemented by using a programmed general-purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the,present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims

What is claimed is:

1. A method for notifying a user regarding an event occurring at a node in a network, the method comprising:
receiving information related to the event, the information being received at a network device;
converting the received information into a syndicated format, the syndicated format being a structured representation of the received information; and
transmitting at least a part of the converted information to notify the user, when a first condition is satisfied.

2. The method of claim 1, wherein the receiving the information about the event comprises receiving a description of the event.

3. The method of claim 1, wherein the syndicated format is an XML compliant format.

4. The method of claim 1, wherein the syndicated format is Really Simple Syndication (RSS) format.

5. The method of claim 1, wherein the transmitting at least a part of the converted information to notify the user, when a first condition is satisfied comprises transmitting the part when the network device is queried for the converted information by a reader application, the reader application being an application capable of accessing websites.

6. The method of claim 1, wherein the transmitting at least the part of the converted information further comprises checking if the subscribed user is authorized to receive the converted information.

7. The method of claim 1, wherein the transmitting the part of the converted information comprises:
transmitting at least a brief description of the received information; and
transmitting a link to the received information.

8. The method of claim 1, wherein the event is a problem that has occurred in the network, the method further comprises:
transmitting at least a brief description of the occurred problem; and
transmitting a link to the node, on which the problem occurred.

9. The method of claim 1, wherein the event is a problem occurred in the network, the method further comprises:
transmitting at least a brief description of the occurred problem; and
transmitting a link to a device in the network, where problem can be solved.

10. The method of claim 1, wherein the transmitting the converted information further comprises transmitting in the form of an RSS feed on the reader application.

11. The method of claim 1, wherein the transmitting the converted information further comprises transmitting the part of the converted information via e-mail to the user.

12. The method of claim 1 further comprising indicating the availability of the converted information on a homepage associated with the network device.

13. The method of claim 1 further comprising providing an option to the user to subscribe to receive information related to the event in the converted format, wherein the option is provided on a homepage associated with the network device.

14. A method for notifying a user regarding an event occurring at a node in a network, the method comprising:
receiving information related to the event, the information being received at a network device;
converting the received information into a syndicated format, the syndicated format being a structured representation of the received information;
providing an option to the user to subscribe for receiving the converted information, the option is provided on a homepage of the network device;
receiving a query from a reader application of a subscribed user regarding the converted information;
checking if the subscribed user is authorized to receive the converted information; and
providing at least a part of the converted information to notify the subscribed user if the subscribed user is authorized to receive the converted information.

15. An apparatus for notifying a user regarding an event occurring at a node in a network, the apparatus comprising:
a receiver receiving information related to the event, the information being received at a network device;
a converter converting the received information into a syndicated format, the syndicated format being a structured representation of the received information; and
a transmitter transmitting at least a part of the converted information to notify the user, when a reader application queries the network device for the converted information.

16. The apparatus of claim 15 further comprising a query receiver for receiving a query from a reader application regarding the converted information.

17. The apparatus of claim 15 further comprising a user checker for checking if the subscribed user is authorized to receive the converted information.

18. The apparatus of claim 15, wherein the network device stores the received information and provides it to an administrator for managing the network.

19. The apparatus of claim 15, wherein the network device is a hub.

20. The apparatus of claim 15, wherein the network device is a switch.

21. The apparatus of claim 15, wherein the network device is a router.

22. A system for notifying a user regarding an event occurring at a node in a network, the system comprising:
means for receiving information related to the event, the information being received at a network device;
means for converting the received information into a syndicated format, the syndicated format being a structured representation of the received information; and
means for transmitting at least a part of the converted information to notify the user, when a reader application queries the network device for the converted information.

23. A machine-readable medium including instructions executable by the processor comprising:
one or more instructions for receiving information related to the event, the information being received at a network device;
one or more instructions for converting the received information into a syndicated format, the syndicated format being a structured representation of the received information; and
one or more instructions for transmitting at least a part of the converted information to notify the user, when a reader application queries the network device for the converted information

24. An apparatus for notifying a user regarding an event occurring at a node in a network, the apparatus comprising:
a processor for executing instructions; and
a machine-readable medium including instructions executable by the processor comprising:
one or more instructions for receiving information related to the event, the information being received at a network device;
one or more instructions for converting the received information into a syndicated format, the syndicated format being a structured representation of the received information; and
one or more instructions for transmitting at least a part of the converted information to notify the user, when a reader application queries the network device for the converted information.
